(19) United States
(12) Patent Application Publication
(10) Pub. No.: US 2022/0108109 A1
(43) Pub. Date: Apr. 7, 2022

(54) Hand draw code system for augmenting paper documents with digital contents using AI

(71) Applicant: FABIO CARBONE, Caltanissetta (IT)

(72) Inventor: FABIO CARBONE, Caltanissetta (IT)

(21) Appl. No.: 17/062,551

(22) Filed: Oct. 3, 2020

(51) Int. Cl. G06K 9/00

(52) U.S. Cl. CPC G06K 9/00476; G06K 9/00456

(57) ABSTRACT

A mobile device software application (app) that allows users to associate digital content with symbols that are hand-drawn (herein referred to as ‘code’) by the user on a writable surface is disclosed. The purpose of the invention is to allow users to associate images, audio, video and any digital file, with such codes on any writable surface (such as a sheet of paper, a blackboard or a wall etc.). The application uses artificial intelligence (AI) and image processing algorithms to distinguish one code from another—as a unique identifier (similar to a fingerprint). This unique association process is the main novelty of the system and it allows users to share codes on mobile devices and view associated content at any time.

### FIELD OF THE INVENTION

The present invention generally relates to mobile device application software. More specifically, it relates to a mobile application that augments paper notes and documents with digital content.

### BACKGROUND

During the early 1950s, Alan Turing (a young British mathematician) was one of the first researchers to explore the mathematical possibility of artificial intelligence. Turing suggested that humans use available information as well as reason in order to solve problems and make decisions and wondered why computers could not do the same. Research was slow. During this time, computers lacked a key prerequisite for intelligence: they couldn't store commands—they could only execute them. In addition, the cost of leasing a computer to conduct such research cost ˜$200,000 a month and only prestigious universities and big technology companies could afford them. Five years later, a logic program was designed to mimic the problem-solving skills of humans and was funded by the RAND Corporation. This program is considered by many to be the first artificial intelligence program and was presented at the Dartmouth Summer Research Project on Artificial Intelligence. In the 1970s computers could store more information and became faster, cheaper, and more accessible. Machine learning algorithms also improved and people got better at knowing which algorithm to apply to specific problems. However, weaknesses continued. The biggest problem was the lack of computational power to do anything substantial: computers simply couldn't store enough information or process it fast enough. In order to communicate, for example, one needs to know the meanings of many words and understand them in many combinations and the computing power was not ready.

In the 1980's, interest in AI was reignited by two sources: an expansion of the algorithmic toolkit, and a boost in private funding. During these years, researchers popularized ‘deep learning’ techniques which allowed computers to learn using experience data. ‘Expert systems which mimicked the decision making process of a human expert also emerged. This program would ask an expert in a field how to respond in a given situation, and once this was learned for virtually every situation, non-experts could receive advice from that program. Expert systems were widely used in industries. In 1997, reigning world chess champion and grand master Gary Kasparov was defeated by IBM's Deep Blue, a chess playing computer program. This highly publicized match was the first time a reigning world chess champion loss to a computer and served as a huge step towards an artificially intelligent decision making program. In the same year, speech recognition software, developed by Dragon Systems, was implemented on Windows computers. This was another great step forward in the direction of the spoken language interpretation endeavor. Kismet, a robot developed by Cynthia Breazeal was an AI system that recognized and displayed human emotions.

2015 was considered to be a landmark year for artificial intelligence as the number of software projects as ‘AI Google’ and ‘neural networks’ became available. These increases in affordable neural networks were due to a rise in cloud computing infrastructure and to an increase in research tools and datasets. Other examples of popular AI include Microsoft's development of a Skype system that automatically translates from one language to another and Facebook's system that can describe images to blind people. Around 2016, China greatly accelerated its government funding (given its large supply of data and its rapidly increasing research output) some observers believe it may be on track to becoming an ‘AI superpower.’ Although the digital revolution and AI has made great strides, many folks prefer to use pen and paper for different purposes—such as taking notes in school, making shopping lists, writing music or taking notes at a meeting etc. The world of paper-writing still coexists with the world of digital writing. Unfortunately these two worlds are not always compatible and precious data can be missed paper notes are not translated in collaborative digital team environments. In some extreme cases, those who prefer paper over digital methods are separated and communication can be compromised (especially between generations).

What is needed is a way to add digital content to a physical paper sheet by means of leveraging AI. For example, a teacher wishes to add notes to a video on YouTube in order to provide more information. Currently, the only existing solution is the Quick Response Code (QR Code). The QR code is a two-dimensional bar code, consisting of black and white square patterns arranged inside a white square-shaped scheme—this symbol is typically used to store in-formation generally intended for be read via a smartphone camera. The QR Code is an excellent method for sharing information and making digital content accessible quickly and easily. However, the QR code does not address the need described above because the process of creating and associating data is slow—first it must be created digitally by a computer, then it must be printed using a printer and finally it must be glued with an adhesive to a piece of paper. The scanning industry has begun looking at ways to allow computers to recognize two-dimensional shapes. U.S. Pat. No. 7,324,691B2 and US20080144942A1 disclosed computer programs that recognize shapes in 2D images; however, they do not encode such images with digital content. United States Patent No. US20080144942A1 disclosed a computer program that associates data with shapes; however, they are not hand-drawn shapes. The current invention allows users to create customized, hand-drawn codes instead of standardized symbols and barcodes. Users can then associate data with said codes instantly using their own device.

### SUMMARY OF THE INVENTION

This invention provides an immediate and easy-to-use method of saving digital information on paper on any writable-surface. This invention is a mobile app comprised of the following parts:

1. Scanner software capable of acquiring images from an existing phone's camera.
2. An AI object detector able to detect a specific hand-draw code in a provided image.
3. An image analysis algorithm able to extract features from the code and compare it with others codes.
4. A database that stores all the registered codes.
5. A database that store all the digital files (image, video, audio, text, link, etc.)
6. A specific user interface that allows you to manage codes and view digital contents.

The code can be any design, such as a smiling face, and object in everyday life etc. The object detector AI within the app must be trained to recognize particular designs over time. The key to making the system work properly and at a high rate of efficiency is that a user image must have a pattern that is recognizable by the object detector—but at the same time, have unique features. In the example app shown in the invention later in this document, cat heads are used and the center of the face can be filled with any doodle or hand drawn sketch to generate a code unique.

The user experience is simple. The user draws a code on a sheet with a normal pen. The user scans the code using their smart phone, tablet etc. If the code has not already been registered by the app, the user can decide to associate the new image with digital content. The app will then store this image and remember this code forever. Whenever users scans the same code again, they will have access to the attached digital content.

The app also provides another type of user experience. Instead of manually selecting the file to be attached from the app, they can use the exchange of information between different apps to get the same result. In this case the user can go to any content on their smartphone, click on ‘Share’ function and indicate to share the content via the app in question. In this way, they can scan a new code and the content will be linked automatically within the app.

There are many situations and environments in which this app can be used. For example: linking a professor's audio to a university's digital clipboard; creating a paper bookmark page; adding written memories to holiday photos; adding music to a musical score; adding long footnotes to a book etc. Wherever and whenever pen and paper is still used, this app can be used to recognize, record, generate codes and archive digital files in a totally new way.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### DESCRIPTION OF THE FIGURES

The accompanying drawings, which are incorporated herein and form a part of the specification, illustrate some, but not the only or exclusive, examples of embodiments and/or features. Other aspects of the present invention shall be more readily understood when considered in conjunction with the accompanying drawings, and the following description, neither of which should be considered limiting.

FIG. 1 shows a perspective view of the invention capturing an image.

FIG. 2 shows a perspective view of the invention screen.

FIG. 3 shows a plan view of the capture screen.

FIG. 4 shows a plan view of the codes.

FIG. 5 shows a plan view of the various association files.

FIG. 6 shows a plan view of the settings.

FIG. 7 shows a representative view of the overall invention structure.

FIG. 8 shows a representative view of the invention process.

### DETAILED DESCRIPTION

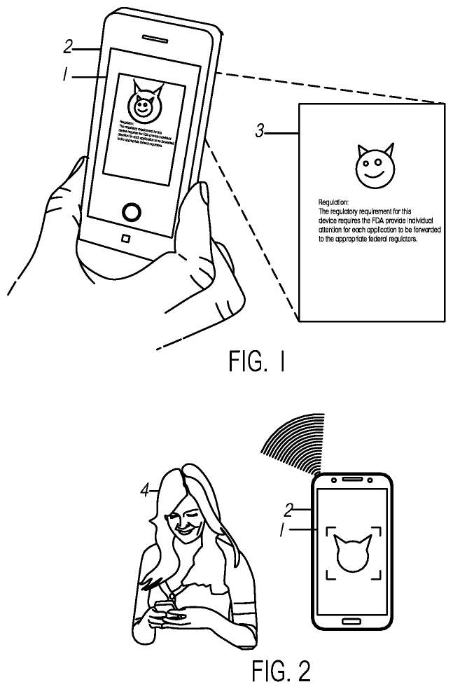

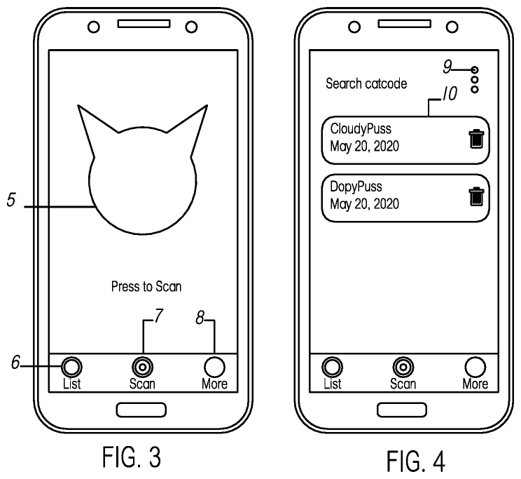

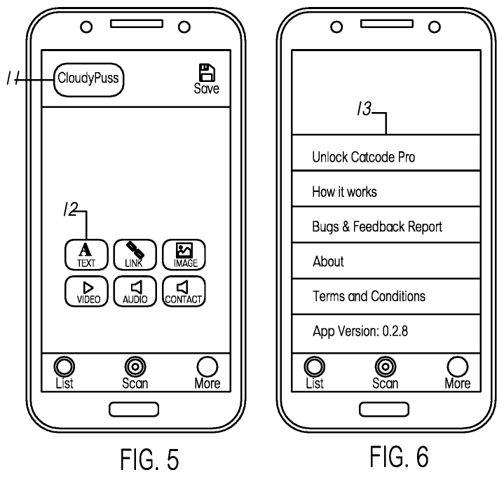

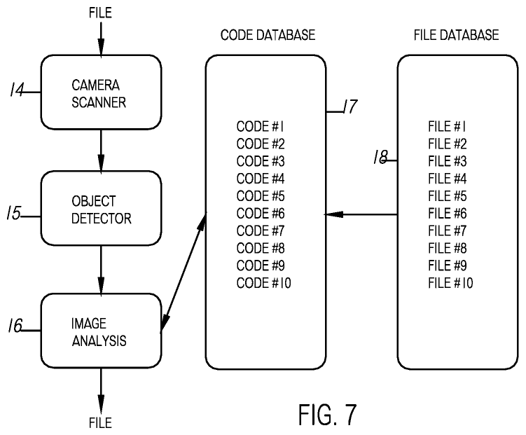

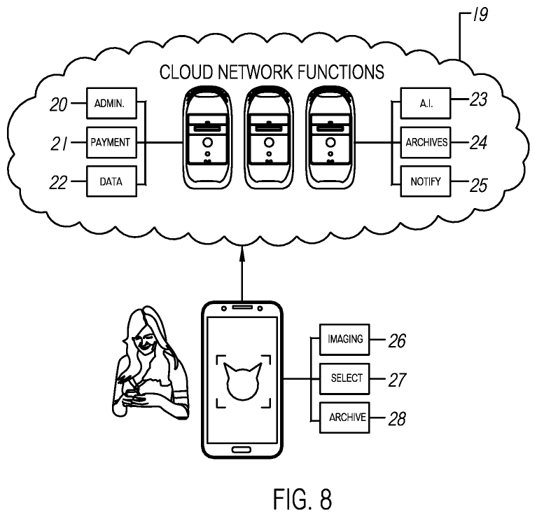

FIGS. 1 and 2 show the preferred embodiment of the main components of the app 1 being used. The user aligns a hand drawn ‘cat's head’ (with hand drawn feature inside) on a sheet of paper 3 within the cat head symbol depicted in app 1 (using a devices such as but not limited to a cell phone 2, tablet, etc.), app 1 executes an object detection routine. FIGS. 3-6 showing the various screens in the app 1 available to the user including but not limited to: image capture screen (with catcode boundary 5, associated file list selection button 6, scan image action button 7 and more button 8); ‘catcode’ directory screen in FIG. 4 (with menu buttons 9, and associated files 10 with file data and deletion option); digital content selection screen with associated file 11 in FIG. 5 (with association options 12 such as text, links, images, video, audio, and contact information) along with a save feature; and FIG. 6 setting screen having options 13 (with unlock pro software version, tutorial, feedback, about, terms and conditions and version identification). FIG. 7 shows the overall structure of the invention functions including but not limited to: a scanned image file being generated on an existing mobile device camera 14 and the software app performing object recognition 15 within the catcode boundary; assigning the recognized object with a file identification 16, the cloud network associating the scanned image with a digital content files selected by the user 17 from files identified in the file database 18. The image is then analyzed and is associated with data and becomes a new file. Each file is assigned a code and file name within the code database. FIG. 8 showing another embodiment of a representative view of the invention process wherein the software app having functions that include but are not limited to: imaging catcodes with a camera on an existing mobile device 26; selecting digital content to associate with an image 27; and archiving the image file and associated digital content file locally 28 and on the cloud network 19. Said cloud network having routines such as but not limited to administrative functions 20 (user demographics, subscription levels, etc.); financial management 21 (venmo, paypal payments etc.); digital content data files 22; A.I. routines 23 (recognizing and predicting shapes within catcode boundaries etc.); archives 24 (digital content files and catcode images etc.); and notifications 25 (sharing alerts, reminders in SMS, text, email and the like).

In the following description, for purposes of explanation, numerous specific details are set forth in order to provide a thorough understanding of the present invention. However, it will be apparent that the invention may be practiced without these specific details. In other instances, well-known structures and devices are shown in block diagram form in order to facilitate describing the present invention. As used in this application, the terms “component”, “handler”, “model”, “system” and the like are used to refer to computer-related entities, hardware, a combination of hardware and software, software, or software at run time. For example, a component may be, but is not limited to being, a process running on a processor, a processor, an object, an executable, a thread of execution, a program, and a computer. By way of illustration, both an application running on a server and a server can be a component. One or more components can reside within a processor and thread of execution and a component can be localized on one computer and distributed between two or more components. In addition, these components can execute from various computer readable media having various data structures stored thereon. Components may, for example, interact with other systems across a network such as the Internet via one or more data packets (data from one component, and signals that interact with components of other systems in a local or distributed system). Communication via local and remote processes in accordance with signals with data from components). The computer component may be stored, for example, on a computer readable medium, which may be an application specific integrated circuit (ASIC), compact disc (CD), digital video disk (DVD), ROM (ROM) according to the present invention. Read Only Memory, floppy disk, hard disk, electrically erasable programmable read only memory (EEPROM), and memory sticks.

In view of the disclosure provided herein, a mobile application is created by techniques known to those of skill in the art using hardware, languages, and development environments known to the art. Those of skill in the art will recognize that mobile applications are written in several languages include, by way of non-limiting examples, C, C++, C #, Objective-C, Java, Javascript, Pascal, Object Pascal, Python, Ruby, VB.NET, WML, and XHTML/HTML with or without CSS, or combinations thereof. The software also compatible with a plurality of operating systems such as, but not limited to: Windows, Apple, and Android, and are compatible with a multitude of hardware platforms such as, but not limited to: personal desktops, laptops, tablets, smartphones and the like. Suitable mobile application development environments are available from several sources. Commercially available development environments include, by way of non-limiting examples, AirplaySDK, alcheMo, Appcelerator, Celsius, Bedrock, Flash Lite, .NET, Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android, SDK, BlackBerry, SDK, BREW SDK, Palm OS SDK, Symbian SDK, webOS SDK, and Windows Mobile SDK. Those of skill in the art will recognize that several commercial forums are available for distribution of mobile applications including, by way of non-limiting examples, Apple, App Store, Google Play, Chrome Web Store, BlackBerry App World, App Store for Palm devices, App Catalog for webOS, Windows Marketplace for Mobile, Ovi Store for Nokia devices, Samsung Apps, and Nintendo DSi Shop etc.

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java, Lisp, Python, Visual Basic, and VB .NET, or combinations thereof. Compilation is often performed, at least in part, to create an executable program. In some embodiments, a computer program includes one or more executable complied applications.

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe Flash Player, Microsoft Silverlight, and Apple QuickTime.

In view of the disclosure provided herein, those of skill in the art will recognize that several plug-in frameworks are available that enable development of plug-ins in various programming languages, including, by way of non-limiting examples, C++, Delphi, Java, PHP, Python, and VB .NET, or combinations thereof. Web browsers (also called Internet browsers) are software applications, designed for use with network-connected digital processing devices, for retrieving, presenting, and traversing information resources on the World Wide Web. Suitable web browsers include, by way of non-limiting examples, Microsoft Internet Explorer, Mozilla Firefox, Google Chrome, Apple Safari, Opera Software Opera, and KDE Konqueror. In some embodiments, the web browser is a mobile web browser. Mobile web browsers (also called micro-browsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google Android browser, RIM BlackBerry Browser, Apple Safari, Palm Blazer, Palm WebOS Browser, Mozilla Firefox for mobile, Microsoft Internet Explorer Mobile, Amazon Kindle Basic Web, Nokia Browser, Opera Software Opera Mobile, and Sony PSP browser. Software Modules. In some embodiments, the platforms, systems, media, and methods disclosed herein include software, server, and/or database modules, or use of the same.

In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth.

What is claimed is:

1. A system for associating digital content to hand drawn codes comprised of the following part:
a) a software application for capturing images and selecting digital content for the association on a mobile device;

2. The system for associating digital content to hand drawn codes of claim 1 wherein the AI algorithms learn hand drawn images and associates said images with digital content.

3. The system for associating digital content to hand drawn codes of claim 1 wherein the capturing of images being performed with the camera on a user's existing mobile device.

4. A method for associating hand drawings with digital content, the method includes the following steps:
a) creating a hand drawing;
b) capturing the hand drawing using the mobile device;
c) learning the hand drawing image captured with the mobile device;
d) associating digital content with the hand draw image; and
e) retrieving associated digital content.

5. The method for associating hand drawings with digital content of claim 4 wherein the user generating the hand drawing.

6. The method for associating hand drawings with digital content of claim 4 wherein the capturing the drawing image is performed using the existing camera on the mobile device.

7. The method for associating hand drawings with digital data of claim 4 wherein the learning the hand drawing image captured in the digital camera is performed using AI.
